(19) United States
(12) Patent Application Publication
(10) Pub. No.: US 2025/0297924 A1
(43) Pub. Date: Sep. 25, 2025

(54) METHODS AND SYSTEMS FOR GENERATING AND USING PREDICTION MODELS FOR ROTATNG MACHINES WITH ROTARY BEARINGS

(71) Applicant: The Boeing Company, Arlington, VA (US)

(72) Inventors: Changzhou Wang, Bellevue, WA (US); Bryce A. Tillack, Littleton, CO (US); Matthew S. McMullen, Lake Forest Park, WA (US)

(73) Assignee: The Boeing Company, Arlington, VA (US)

(21) Appl. No.: 18/615,104

(22) Filed: Mar. 25, 2024

(51) Int. Cl. G01M 99/00; G06N 20/00

(52) U.S. Cl. CPC G01M 99/005; G06N 20/00

(57) ABSTRACT

A method for generating a prediction model to predict a non-compliance condition of a rotating machine with rotary bearings includes determining an average actual failure rate for the rotating machine based on maintenance records; receiving pressure sensor data relating to an inlet pressure and an outlet pressure of the rotating machine; determining select characteristics of the rotating machine associated with a preoperational period, an operational period and/or a post-operational period of the rotating machine; and building the prediction model for the rotating machine based on the average actual failure rate and the select characteristics. Systems for generating the prediction model include a computing device and a storage device. Non-transitory computer-readable medium associated with generation of the prediction model is also disclosed. Methods for using the prediction model to predict a non-compliance condition of a rotating machine with rotary bearings, associated systems and associated non-transitory computer-readable medium are also disclosed.

### FIELD

The present disclosure relates generally to models to predict non-compliance conditions for rotating machines with rotary bearings and, particularly, to generating and using the prediction model to predict the non-compliance conditions based on pressure sensor data. Inlet and outlet pressure sensors associated with the rotating machine capture the pressure sensor data. The pressure sensor data from the inlet pressure sensor is indicative of inlet pressure of an inlet path to the rotating machine. The pressure sensor data from the outlet pressure sensor is indicative of outlet pressure of an outlet path from the rotating machine. The pressure sensor data over time is indicative of wear on rotary bearings within the rotating machine and changes in friction due to such wear.

### BACKGROUND

Rotating machines containing turbine or compressor, such as the Air Cycle Machine and Cabin Air Compressor on aircraft, use air bearings between the shaft and journal to minimize friction for a long operation life. As these components age over time or suffer mechanical damage, the air bearings may degenerate, and friction may increase. Increased friction often causes the turbine components to decelerate more quickly than normal and accelerate more slowly, and components with controlled acceleration require more power to maintain acceleration. Failure of these components can be predicted based on the machine's rotational speed sensor data. However, existing solutions depend on speed sensors which might not be provided in the rotating machines by the manufacturer.

Accordingly, those skilled in the art continue with research and development efforts to sense characteristics of rotating machines that are indicative of degradation to predict subsequent failures.

### SUMMARY

Disclosed are examples of methods and systems for generating a prediction model to predict a non-compliance condition of a rotating machine with rotary bearings, non-transitory computer-readable medium associated with implementing the generating methods, methods and systems for predicting a non-compliance condition of a rotating machine with rotary bearings and non-transitory computer-readable medium associated with implementing the predicting methods. The following is a non-exhaustive list of examples, which may or may not be claimed, of the subject matter according to the present disclosure.

In an example, the disclosed method for generating a prediction model to predict a non-compliance condition of a rotating machine with rotary bearings includes: (i) determining an average actual failure rate for the rotating machine based at least in part on maintenance records for a first plurality of the rotating machine; (ii) receiving pressure sensor data relating to an inlet pressure and an outlet pressure for a second plurality of the rotating machine, the pressure sensor data having been recorded during at least one of a preoperational period, an operational period and a post-operational period of the second plurality of the rotating machine; (iii) determining select characteristics of the rotating machine associated with at least one of the preoperational period, the operational period and the post-operational period based at least in part on the pressure sensor data; and (iv) building the prediction model for the rotating machine based at least in part on the average actual failure rate and the select characteristics.

In an example, the disclosed system for generating a prediction model to predict a non-compliance condition of a rotating machine with rotary bearings includes at least one computing device and at least one storage device. The at least one computing device includes at least one processor, associated memory and a network interface. The network interface in operative communication with the at least one processor and configured to communicate with a pressure sensor data repository via a communication network. The at least one storage device includes at least one application program storage device, at least one model storage device and at least one data storage device. The at least one application program storage device in operative communication with the at least one processor and configured to store a maintenance record analysis application program, a sensor data analysis application program and a model generation application program. The at least one model storage device in operative communication with the at least one processor and configured to store the prediction model for the rotating machine. The at least one data storage device in operative communication with the at least one processor and configured to store maintenance records for a first plurality of the rotating machine, an average actual failure rate for the rotating machine and pressure sensor data associated with a second plurality of the rotating machine.

In an example, the disclosed non-transitory computer-readable medium includes instructions that, when executed by at least one processor, cause at least one computing device to perform a method for generating a prediction model to predict a non-compliance condition of a rotating machine with rotary bearings. The method includes: (i) determining an average actual failure rate for the rotating machine based at least in part on maintenance records for a first plurality of the rotating machine; (ii) receiving pressure sensor data relating to an inlet pressure and an outlet pressure for a second plurality of the rotating machine, the pressure sensor data having been recorded during at least one of a preoperational period, an operational period and a post-operational period of the second plurality of the rotating machine; (iii) determining select characteristics of the rotating machine associated with at least one of the preoperational period, the operational period and the post-operational period based at least in part on the pressure sensor data; and (iv) building the prediction model for the rotating machine based at least in part on the average actual failure rate and the select characteristics.

In an example, the disclosed method for predicting a non-compliance condition of a rotating machine with rotary bearings includes: (i) receiving pressure sensor data relating to an inlet pressure and an outlet pressure for the rotating machine, the pressure sensor data having been recorded during at least one of a preoperational period, an operational period and a post-operational period of the rotating machine; (ii) determining select characteristics of the rotating machine associated with at least one of the preoperational period, the operational period and the post-operational period based at least in part on the pressure sensor data; and (iii) processing an average actual failure rate and the select characteristics using a prediction model for the rotating machine to predict the non-compliance condition of the rotating machine.

In an example, the disclosed system for predicting a non-compliance condition of a rotating machine with rotary bearings includes at least one computing device and at least one storage device. The at least one computing device includes at least one processor, associated memory and a network interface. The network interface in operative communication with the at least one processor and configured to communicate with an end item in which the rotating machine is installed via a communication network. The at least one storage device includes at least one application program storage device, at least one model storage device and at least one data storage device. The at least one application program storage device in operative communication with the at least one processor and configured to store a sensor data analysis application program and a maintenance prediction application program. The at least one model storage device in operative communication with the at least one processor and configured to store the prediction model for the rotating machine. The at least one data storage device in operative communication with the at least one processor and configured to store an average actual failure rate for the rotating machine and pressure sensor data associated with the rotating machine.

In an example, the disclosed non-transitory computer-readable medium includes instructions that, when executed by at least one processor, cause at least one computing device to perform a method for predicting a non-compliance condition of a rotating machine with rotary bearings. The method includes: (i) receiving pressure sensor data relating to an inlet pressure and an outlet pressure for the rotating machine, the pressure sensor data having been recorded during at least one of a preoperational period, an operational period and a post-operational period of the rotating machine; (ii) determining select characteristics of the rotating machine associated with at least one of the preoperational period, the operational period and the post-operational period based at least in part on the pressure sensor data; and (iii) processing an average actual failure rate and the select characteristics using a prediction model for the rotating machine to predict the non-compliance condition of the rotating machine.

Other examples of the disclosed methods and systems for generating a prediction model to predict a non-compliance condition of a rotating machine with rotary bearings, non-transitory computer-readable medium associated with implementing the generating methods, methods and systems for predicting a non-compliance condition of a rotating machine with rotary bearings and non-transitory computer-readable medium associated with implementing the predicting methods will become apparent from the following detailed description, the accompanying drawings and the appended claims.

### BRIEF DESCRIPTION OF THE DRAWINGS

FIG. 1 is a functional diagram of an example of a rotating machine with rotary bearings;

FIG. 2 is a graph showing the behavior of examples of relevant parameter for a rotating machine in relation to a shutdown event;

FIG. 3 is a heat map showing an example of delta pressure calculations over time in relation to a shutdown event;

FIG. 4 is a graph showing examples of delta pressure increases over time in relation to startup events and delta pressure drops over time in relation to shutdown events;

FIG. 5 is a flow diagram of an example of a method for generating a prediction model to predict a non-compliance condition of a rotating machine with rotary bearings;

FIG. 6, in combination with FIG. 5, is a flow diagram of another example of a method for generating a prediction model to predict a non-compliance condition of a rotating machine with rotary bearings;

FIG. 7 is a flow diagram of an example of the determining of the select characteristics of FIG. 5;

FIG. 8 is a flow diagram of another example of the determining of the select characteristics of FIG. 5;

FIG. 9, in combination with FIG. 5, is a flow diagram of yet another example of a method for generating a prediction model to predict a non-compliance condition of a rotating machine with rotary bearings;

FIG. 10, in combination with FIG. 5, is a flow diagram of still another example of a method for generating a prediction model to predict a non-compliance condition of a rotating machine with rotary bearings;

FIG. 11 is a functional block diagram of an example of a system for generating a prediction model to predict a non-compliance condition of a rotating machine with rotary bearings;

FIG. 12 is a flow diagram of an example of a method for predicting a non-compliance condition of a rotating machine with rotary bearings;

FIG. 13, in combination with FIG. 12, is a flow diagram of another example of a method for predicting a non-compliance condition of a rotating machine with rotary bearings;

FIG. 14 is a flow diagram of an example of the determining of the select characteristics of FIG. 12;

FIG. 15, in combination with FIG. 12, is a flow diagram of yet another example of a method for predicting a non-compliance condition of a rotating machine with rotary bearings;

FIG. 16 is a functional block diagram of an example of a system for predicting a non-compliance condition of a rotating machine with rotary bearings;

FIG. 17 is a block diagram of aircraft production and service methodology that implements one or more of the examples of methods for generating a prediction model to predict a non-compliance condition of a rotating machine with rotary bearings disclosed herein or one or more of the examples of methods for predicting a non-compliance condition of a rotating machine with rotary bearings disclosed herein; and

FIG. 18 is a schematic illustration of an aircraft that incorporates one or more examples of rotating machines with rotary bearings maintained in conjunction with one or more of the examples of methods and systems for generating a prediction model to predict a non-compliance condition of a rotating machine with rotary bearings disclosed herein or one or more of the examples of methods and systems for predicting a non-compliance condition of a rotating machine with rotary bearings disclosed herein.

### DETAILED DESCRIPTION

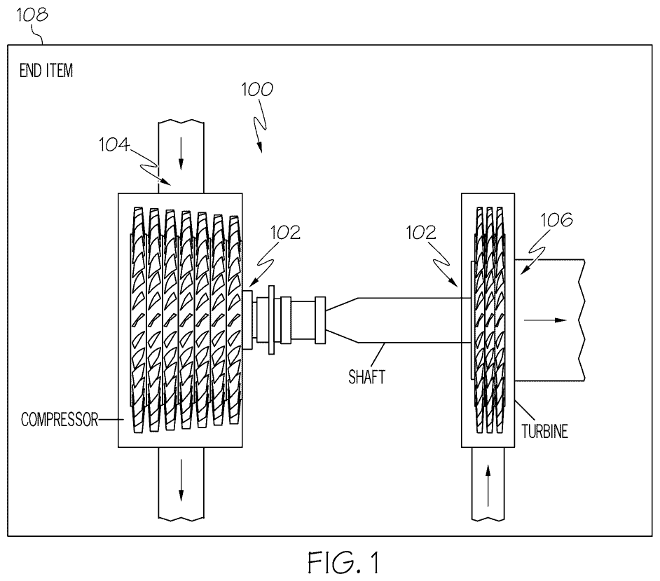

Many rotating machines 100 (see FIG. 1) containing turbine or compressor on an aircraft, such as the Air Cycle Machine and Cabin Air Compressor, may use rotary bearings 102 between the shaft and journal to minimize friction for a long operation life. As these components age over time or suffer mechanical damage, the rotating bearings 102 may degenerate and friction may increase. Increased friction often cause the turbine components to accelerate or decelerate much more quickly than normal. As a result, one might wish to use the machine's rotational speed sensor data to predict future failure of the components.

However, some rotating machines 100 (see FIG. 1) are built without an actual speed sensor and relying on rotation speed readings calculated from the electric frequency of the driving motors. In this case, an alternative method is necessary to find how quickly the turbine/compressor accelerates or decelerates as a means of checking the machine's health, especially if the rotation speed reading is no longer available when electric power is removed during shutdown. Often, there are temperature sensors and pressure sensors 104, 106 on both the inlet and outlet of the component. When the component fully stops, the pressure and temperature differences between inlet and outlet shall be minimal, subject to sensor calibration and precision margins. These parameters may serve as a proxy for the speed measurement that would otherwise be used in the predictions of rotating machine life.

In addition, even components of the same specification are built with subtle differences so that their normal profiles of acceleration or deceleration can be different. It is usually not possible to create prediction rules about time to future failure with exact thresholds solely from the engineering knowledge such as aerodynamics theory and design specifications of the components. Instead, the engineering knowledge may be combined with actual pressure sensor data for predicting failures of such turbine components. In particular, features can be extracted from each shutdown event or each startup event with similar structure but allow different window size and thresholds, and then use operational data to select the best choices based on cross-flight trends and their correlation with component failures.

The delta pressure (outlet minus inlet pressure) is selected over delta temperature, due to the relatively slow changes of temperature (in comparison with pressure) and temperature variations between inlet and exit materials.

Ideally, the inlet and outlet pressure are measured near the actual physical inlet and outlet of the target component. For example, sometimes, the Cabin Air Compressor inlet pressure might not be recorded, or its recording does not have high-enough resolution. In this case, ambient pressure might be used as surrogate. If ambient pressure is not directly measured, it might be derived from altitude using the standard atmosphere models. However, these surrogates often differ from the actual inlet pressure, due to the variation of local atmospheric conditions, airplane speed, angle of attack, etc. Actual operation data are necessary to investigate whether the difference is too big to make reliable prediction.

In addition, to compare the inferred rotational acceleration or deceleration of the same component across different flights, it is often desirable to ensure that the component is operating in a similar condition. This usually involves checking for differences within the system such as a few valves controlling the airflow into and out of the component and picking an operation point (for failure prediction later) where all external variables are mostly consistent from flight to flight. For example, for the Cabin Air Compressor, there might be Add Heat valves and Variable Diffusor valves, which change the airflow route or shape (and size). Often, these valves are commanded to be in the same position during startup or shutdown, and abnormal cases can be ignored. Otherwise, their positions need to be used to normalize the acceleration or deceleration time.

In addition to sensor data, the actual component failure times also need to be identified, often from different data sources. Usually, a failed component is not replaced immediately, as there are often redundant components on the aircraft. As a result, we need to differentiate replacement time from the failure time. Maintenance data often includes records about when a component is inspected and replaced. Sometimes, complaints about the component or manual deactivation of the components are also recorded. Such maintenance records might not be complete or accurate, due to an operator's manual input process. Sensor data can be used to confirm failures, as the component is often deactivated for flights between failure and replacement and the pressure sensors 104, 106 will reflect the operator's deliberate component deactivation.

While the objective is to predict the machine's impending failure, not the replacement, the replacement time is used to partition the sequence of flights into segments so that the same segment corresponds to the same component (instance).

Intra-flight feature creation relies mostly on engineering knowledge. For rotating machines 100 (see FIG. 1) with rotating bearings 102, it is often safe to assume the following hypothesis: the speed acceleration at component startup and speed deceleration at component shutdown both increase in magnitude as the bearings 102 incur friction and degenerate toward failure.

Given this high-level hypothesis, the full flight sensor data is used to find out: (i) Are there data available for startup or shutdown? (ii) How to calculate the acceleration or deceleration rates? (iii) How to determine if the acceleration/deceleration is increasing or not?

First, the relevant parameters of the target component, together with key flight phase-related parameters such as pressure altitude and ground speed, of a few sample flights are extracted for visual examination. This will help determine the availability of the data. For example, for the Cabin Air Compressor, only two (out of four on the same airplane) shut down during the normal data recording period. This triggers actions to update/add data recording logic to capture other shutdown events.

Now, with necessary data, the logic to find out the exact startup or shutdown period is determined, accommodating noisy data. For example, control mode changes can be used as a triggering signal to detect shutdown, but the rotation speed (calculated from electric frequency, not actual speed, hence drops immediately to zero after mode switch) can also be used as additional indicator of machine shutdown. In addition, noisy transient conditions can be ignored by looking forward and backward as shown in the following example of pseudo code:

```
event template CacDown(Parameter<Double> rpm, Parameter<Double> mode, Time
backward=5s, Time forward=25s) {
  at mode != 7;
  where this.time−backward >= input.start and this.time+forward <= input.end;
  where look forward from this.time: mode!=7;
  where look backward to this.time: mode==7;
  where (rpm > 10).covers(this.time−backward, this.time−1s) and (rpm <
  10).covers(this.time+1s, this.time+forward);
}
```

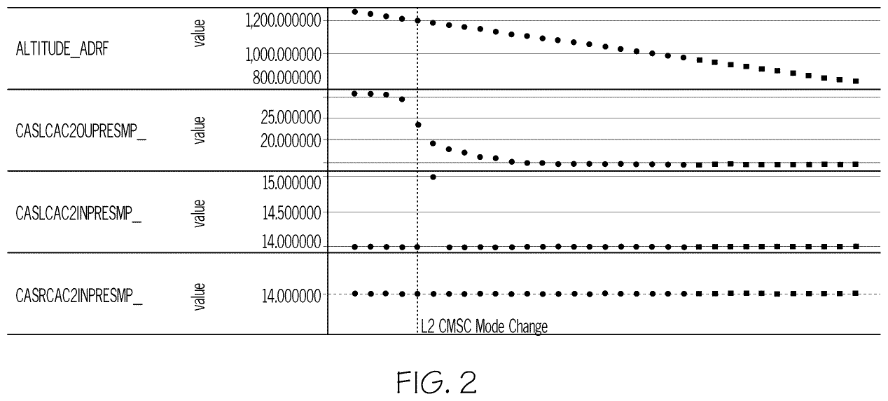

From sample flights with shutdown events, as shown in FIG. 2, relevant parameters can be visualized at the time of shutdown (or startup). This helps to better understand the behavior of relevant parameters at the events of interest.

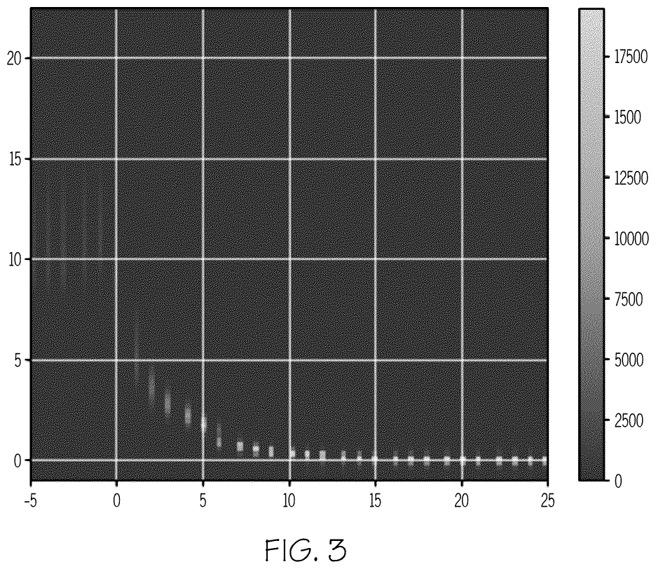

It is also necessary to visualize the features over many, if not all, flights. For example, the delta pressure can be calculated at times relative to the moment shutdown initiates and visualized as a heat map (see FIG. 3), where the x-axis is delta seconds relative to the shutdown moment, and y-axis is the delta pressure, and color indicates the number of flights.

This enables the creation of features to measure the acceleration and deceleration rate. Note that the inlet and outlet pressures are measured by different sensors, and hence the calculated delta pressure might not be zero due to the different calibration errors of the sensors as well as the measurement accuracy margins. Hence, we find a stable period first, and use the median (or other quantile) value of the delta pressure during the stable period, instead of zero, as the “equilibrium delta pressure”.

With stable period and the equilibrium delta pressure identified, the time (number of seconds) can be calculated for the delta pressure to drop from a given value to that equilibrium value or increase from the equilibrium value to a given value. For example, the time can be calculated using the following pseudo code:

```
function Map<String, Double> dp2s(String name, TimePredicate cond,
    Parameter<Double> rpm, Parameter<Double> mode, Parameter<Double> deltaP,
    List<Double> tolerances, List<Double> drops, List<Int> stableStart,
    List<Int> stableLen, Time backward=5s, Time forward=55s) {
  var modeNe7 = (mode != 7) and cond;
  var time = [?s for s:e in modeNe7.intervals if s−backward>=input.start
    and s+forward <= input.end and (modeNe7 and rpm<10).covers(s+2s, s+forward)
    and (not modeNe7 and rpm>10).covers(s−backward, s−2s)][0];
  return [?name+“_S”+ss+“+”+sl+“_D”+d+“t”+t: (end-start)/1s
      for ss in stableStart for sl in stableLen for t in tolerances
      for d in drops
      for stable in [deltaP.median(time +ss*1s, time +(ss+sl)*1s)]
      for end in [(deltaP.clip(time, time +ss*1s)<=stable+t).starts[0]]
      for start in [(deltaP.clip(time, time +end)<=stable+t+d).starts[0]]];
    }
```

Here, the logic allows different choices to determine when the stable period starts, how long it lasts, how much tolerance is allowed when comparing the delta pressure with the equilibrium delta pressure in the stable period, or how much delta pressure drop is achieved during the shutdown. The logic is backed up by general engineering reasoning, but the actual choices depend on the feature performance in operation data.

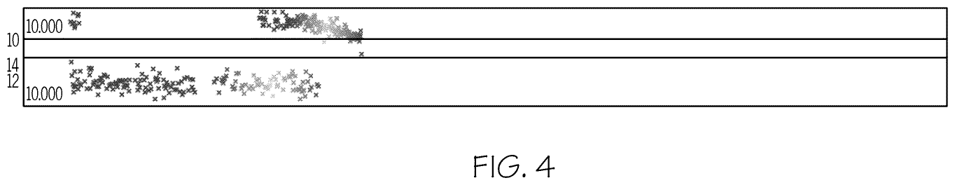

With reference to FIG. 4, two examples of delta pressure (with specific choices) drop time are shown over different flights, one with clear downward trend, and the other without, toward the failure time (red).

In addition to the time of delta pressure drop or increase, additional features can be calculated. For example, the slope of the delta pressure changes can be used. The slope may be calculated with different windows during shutdown (or startup), or different quantiles of slopes using moving windows of different sizes.

With features such as Delta-Pressure-Drop-Until-Stable for shutdown, extracted from flights, machine learning algorithms can be used to predict component failures from these features. The simplest method here is to use a regression algorithm, such as generalized linear regression or random forest regression, to predict the time to failure for each flight using the features calculated from the parameter data during the flight. This method treats each flight as an independent case and ignores the temporal progress of component degeneration. The simple method can be enhanced, e.g., by predicting the logarithm of the time to failure, as higher precision is required as it is closer to failure. For example, it might be okay to predict 120 days to failure as 100 days to failure, but it is not acceptable to predict 21 days to failure as 1 day to failure.

In addition, higher-order features, called inter-flight features, can be created from the intra-flight features. Engineers with domain knowledge often look at the trend of the intra-flight features and use the history of the same component (instance) to find precursors of the failures. As a result, the following inter-flight features can be derived using the Delta-Pressure-Drop-Until-Stable as an example: (i) Windowed moving quantiles over flights using the same component (since installation to failure). Multiple window sizes, such as 30 days, 60 days, and 90 days, can be used. Similarly, multiple quantile cut thresholds, such as 10%, 50% and 90%, can be used; (ii) Calculate the ratios between different pairs of windowed moving quantiles, e.g., 30-day 10% moving quantile divided by 90 day 90% moving quantiles; and (iii) Fit the sequences (from flights using the same component) into line or curve segments, for example, use Spline lines of degree 1 or 2 and different maximum fitting errors. Different moving windows can be used to select flights to fit.

Note that there are many hyper-parameters, such as half-life, window size, Spline degree and maximum fitting error. As a result, there will be many inter-flight features that can be derived from the same intra-flight feature.

With these inter-flight features, machine learning algorithms can be applied, such as random forest, to predict failure from them. Now, instead of predicting the exact time to failure, whether the component will fail within a given X number of days can be predicted. Here, X is determined by the maintenance and operation needs: replacement should be scheduled in advance so that relevant parts can be provided and schedule interruptions can be minimized.

A process to build a prognosis model for predicting failures for rotating machines that include rotary bearings 102 with inlet and outlet pressure sensors 104, 106 instead of actual speed sensors may include update data capturing/recording logic, if necessary, to ensure inlet and outlet pressures are recorded during component startup and shutdown periods. Also, collect all recorded sensor data. Additionally, determine failure time of each component in historical data, using maintenance records and sensor readings in actual flights. Furthermore, identify startup and shutdown periods for each component in each flight, calculate delta pressure from each sample during such periods. Moreover, find stable period (when the component is not operating) and determine the equilibrium delta pressure. Also, for each startup or shutdown event, generate features based on the change of delta pressure after or before equilibrium point. This includes the time from/to equilibrium delta pressure to/from a given target delta pressure value, the slope of changes or other coefficients used to fit the change profile into some predefined curves. This also includes use machine learning and/or statistical analysis methods to sub-select combinations of window sizes and thresholds in defining those features, so that they have the best differentiating power between flights close to failure and other flights considered normal for the component. Additionally, for each component, from installation to failure, aggregate the above features across flights using moving windows, quantile calculation, curve fittings, or change detection methods. This also includes similarly, use machine learning and/or statistical analysis methods to sub-select combinations of aggregation settings, so that they have the best differentiating power between flights close to failure and other flights considered normal for the component. Furthermore, use machine learning methods to build models for predicting component failure from the aggregated features.

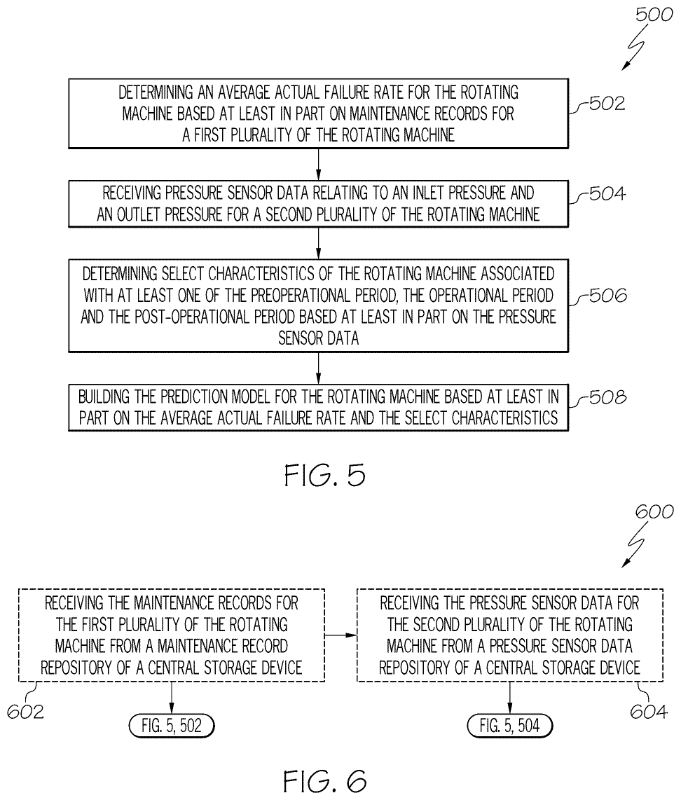

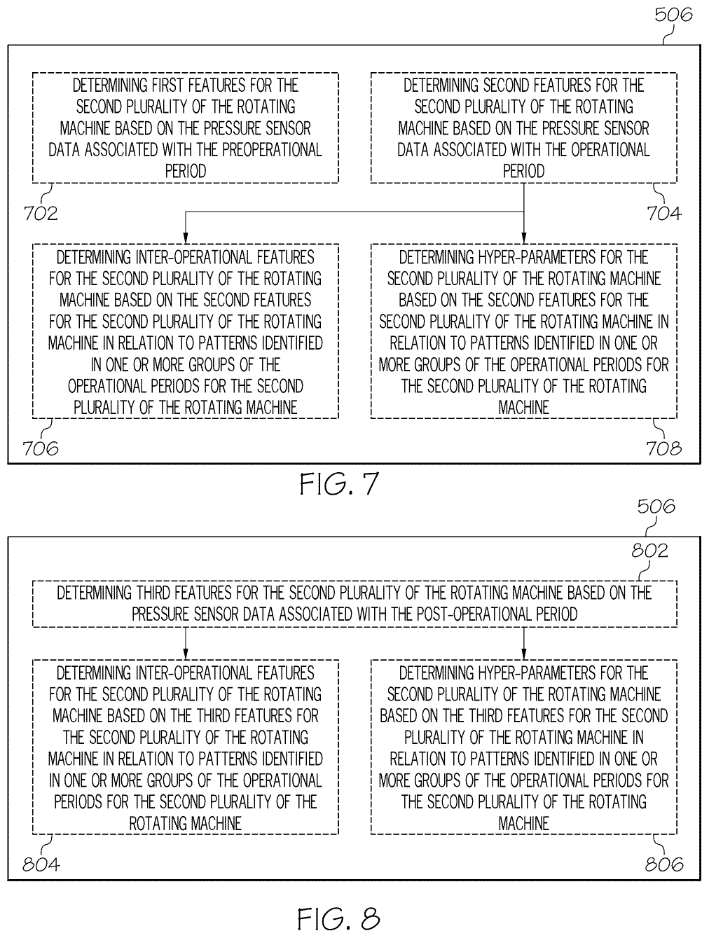

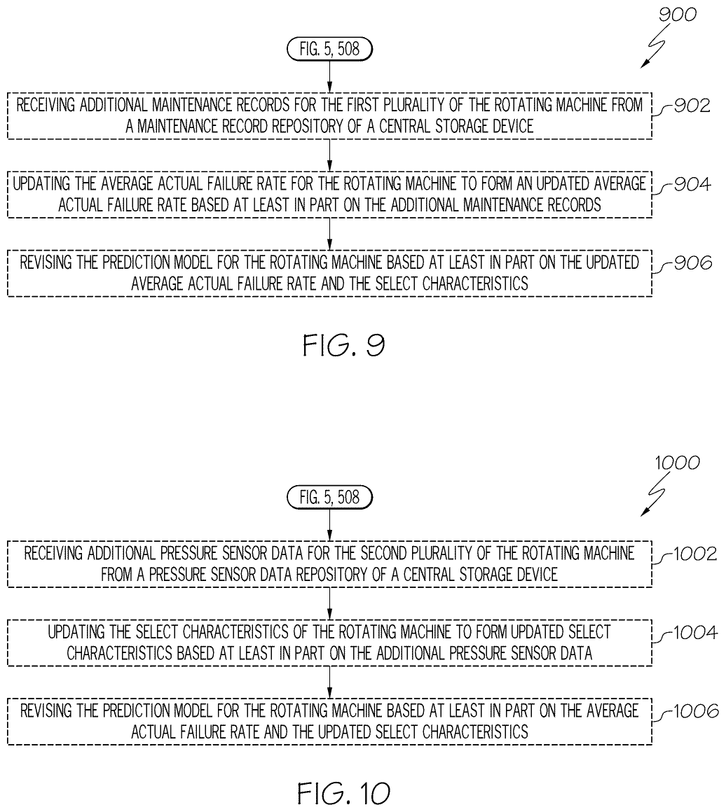

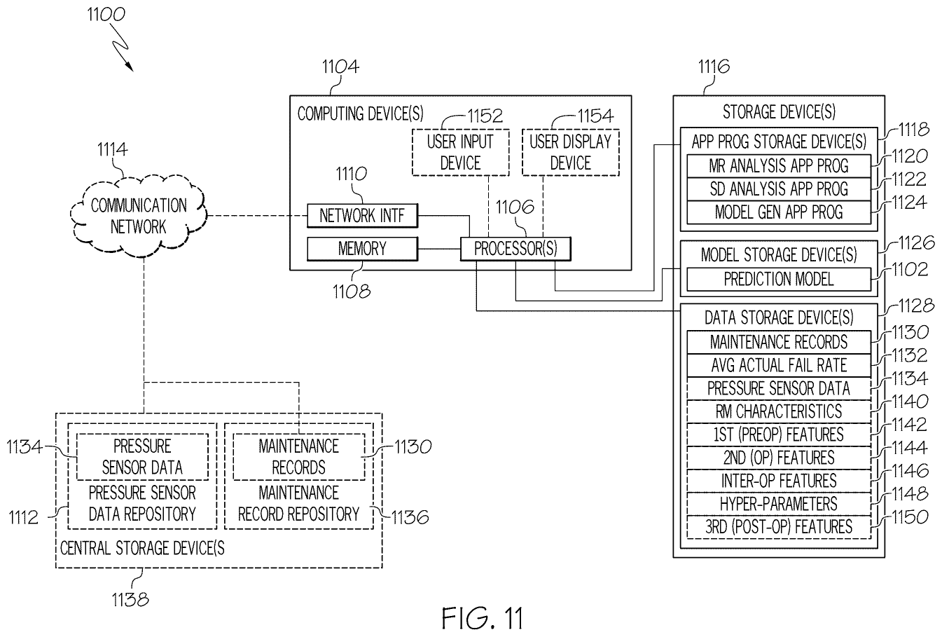

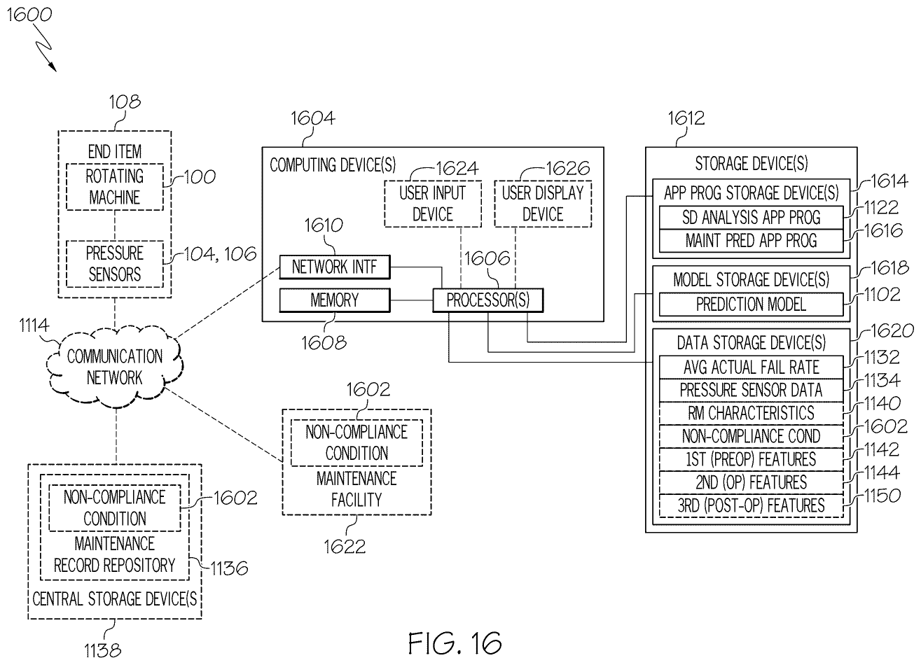

Referring generally to FIGS. 1, 5-11 and 16, by way of examples, the present disclosure is directed to a method 500, 600, 900, 1000 for generating a prediction model 1102 to predict a non-compliance condition 1602 of a rotating machine 100 with rotary bearings 102. FIG. 1 provides an example of the rotating machine 100 with the rotary bearings 102. FIG. 5 provides an example of the method 500 for generating a prediction model 1102 to predict a non-compliance condition 1602 of a rotating machine 100 with rotary bearings 102. FIG. 6, in combination with FIG. 5, provides an example of the method 600. FIG. 7 provides an example of the determining 506 of the select characteristics 1140 of FIG. 5. FIG. 8 provides another example of the determining 506 of the select characteristics 1140 of FIG. 5. FIG. 9, in combination with FIG. 5, provides an example of the method 900. FIG. 10, in combination with FIG. 5, provides an example of the method 1000. FIG. 11 provides an example of a system 1100 for generating the prediction model 1102 to predict the non-compliance condition 1602 of the rotating machine 100 with the rotary bearings 102. FIG. 16 provides an example of a system 1600 for predicting the non-compliance condition 1602 of the rotating machine 100 with the rotary bearings 102.

With reference again to FIGS. 1, 5, 7, 8, 11 and 16, in one or more examples, a method 500 (see FIG. 5) for generating a prediction model 1102 to predict a non-compliance condition 1602 of a rotating machine 100 with rotary bearings 102 includes determining 502 an average actual failure rate 1132 for the rotating machine 100 based at least in part on maintenance records 1130 for a first plurality of the rotating machine 100. At 504, pressure sensor data 1134 relating to an inlet pressure and an outlet pressure for a second plurality of the rotating machine 100 is received. The pressure sensor data 1134 having been recorded during at least one of a preoperational period, an operational period and a post-operational period of the second plurality of the rotating machine 100. At 506, select characteristics 1140 of the rotating machine 100 associated with at least one of the preoperational period, the operational period and the post-operational period are determined based at least in part on the pressure sensor data 1134. At 508, the prediction model 1102 for the rotating machine 100 is built based at least in part on the average actual failure rate 1132 and the select characteristics 1140.

In another example of the method 500, the non-compliance condition 1602 includes a degraded condition, a failure condition or any other suitable non-compliance condition in any suitable combination. In yet another example of the method 500, the rotating machine 100 includes a compressor, a turbine, a pump, an air cycle machine, a cabin air compressor or any other suitable rotating machine in any suitable combination. In still another example of the method 500, the rotary bearings 102 include fluid bearings, air bearings, aerodynamic bearings, aerostatic bearings, fluid dynamic bearings, foil bearings, hydrodynamic bearings, tilting-pad fluid bearings, fluid static bearings, hydrostatic bearings, gas bearings, water-lubricated rubber bearings, plain bearings, rolling-element bearings, ball bearings, roller bearings, jewel bearings, magnetic bearings, flexure bearings or any other suitable rotary bearings in any suitable combination. In still yet another example of the method 500, the prediction model 1102 for the rotating machine 100 is associated with a select manufacturer and a select model number of the rotating machine 100. In another example of the method 500, the prediction model 1102 for the rotating machine 100 is associated with a select manufacturer and select model numbers of the rotary bearings 102. In yet another example of the method 500, the maintenance records 1130 include historical maintenance records, failure records for the first plurality of the rotating machine 100 or any other suitable maintenance records in any suitable combination.

In still another example of the method 500, the pressure sensor data 1134 includes inlet pressure measurements by a first pressure sensor 104 disposed proximate an inlet of the rotating machine 100 and outlet pressure measurements by a second pressure sensor 106 disposed proximate an outlet of the rotating machine 100. In a further example, at least one of the first pressure sensor 104 and the second pressure sensor 106 are external in relation to the rotating machine 100. In another further example, at least one of the first pressure sensor 104 and the second pressure sensor 106 are internal in relation to the rotating machine 100. In yet another further example, the pressure sensor data 1134 includes unique identifying information associated with a given rotating machine 100 of the second plurality of the rotating machine 100. In still another further example, the pressure sensor data 1134 includes unique identifying information associated with a given pair of rotary bearings 102 in a given rotating machine 100 of the second plurality of the rotating machine 100.

In still yet another further example, the pressure sensor data 1134 includes unique identifying information associated with an end item 108 in which given rotating machine 100 of the second plurality of the rotating machine 100 is installed. In an even further example, the end item 108 includes an aircraft, a rotorcraft, a bus, a train conductor car, train crew quarters, a passenger train car, a passenger transport vehicle, a military transport vehicle, an operational military vehicle, a battle tank, a power plant, an unmanned air vehicle, a ship, a ferry, a cruise ship, a military ship, a ship's bridge room, a ship's engine control room, ship crew quarters, ship passenger quarters, a commercial building, a residential building or any other suitable end item in any suitable combination. In another further example, the pressure sensor data 1134 includes temporal information associated with the inlet pressure measurements and the outlet pressure measurements. In yet another further example, the pressure sensor data 1134 includes an indicator associating the inlet pressure measurements and the outlet pressure measurements with the preoperational period, the operational period or the post-operational period.

In another example of the method 500, the rotating machine 100 is deactivated during the preoperational period which ends when power is applied to the rotating machine 100. In yet another example of the method 500, the operational period begins when power is applied to the rotating machine 100 and ends when the power is removed. In still another example of the method 500, the post-operational period begins when power is removed from the rotating machine 100 and ends when a pressure differential between an outlet of the rotating machine 100 and an inlet of the rotating machine 100 is nominal and stable for a predetermined time.

With reference again to FIGS. 1, 5, 6 and 11, in one or more examples, a method 600 (see FIG. 6) for generating a prediction model 1102 to predict a non-compliance condition 1602 of a rotating machine 100 with rotary bearings 102 includes the method 500 of FIG. 5. The method 600 begins at 602 where the maintenance records 1130 for the first plurality of the rotating machine 100 are received from a maintenance record repository 1136 of a central storage device 1138. The method 600 continues from 602 to 502 of FIG. 5. The method 600 may also continue to 604 where the pressure sensor data 1134 for the second plurality of the rotating machine 100 is received from a pressure sensor data repository 1112 of a central storage device 1138. In a further example, the central storage device 1138 includes a cloud storage device, a remote storage device, a local storage device or any other suitable central storage device in any suitable combination.

With reference again to FIGS. 1, 5, 7, 8, 11 and 16, in another example of the method 500, the determining 506 of the select characteristics 1140 includes determining 702 first features 1142 for the second plurality of the rotating machine 100 based on the pressure sensor data 1134 associated with the preoperational period. In a further example, the first features 1142 include a preoperational delta pressure, an equilibrium delta pressure based at least in part on the preoperational delta pressure or any other suitable preoperational feature in any suitable combination. In yet another example of the method 500, the determining 506 of the select characteristics 1140 includes determining 704 second features 1144 for the second plurality of the rotating machine 100 based on the pressure sensor data 1134 associated with the operational period.

In a further example, the second features 1144 includes i) identification of a startup event based at least in part on application of power to a given rotating machine 100 of the second plurality of the rotating machine 100, ii) a calculated delta pressure based on a difference between an outlet pressure measurement of the rotating machine 100 and an inlet pressure measurement over time, iii) a first equilibrium delta pressure associated with the startup event, iv) a time after the startup event until at least one of a target delta pressure and a second equilibrium delta pressure is reached, v) changes in the calculated delta pressure after the startup event until at least one of the target delta pressure is reached, a predetermined delta pressure increase is reached and the second equilibrium delta pressure is reached, vi) a slope of the changes in the calculated delta pressure, vii) a change profile based at least in part on the changes in the calculated delta pressure, viii) identification of normalization coefficients to fit the change profile to predefined change profile curves or any other suitable operational feature in any suitable combination.

In another further example, where at least a portion of the pressure sensor data 1134 was sampled at a 20 Hertz rate or higher, the second features 1144 are determined based at least in part on the portion of the pressure sensor data 1134 sampled at the 20 Hertz rate or higher. In yet another further example, the determining 506 of the select characteristics 1140 also includes determining 706 inter-operational features 1146 for the second plurality of the rotating machine 100 based on the second features 1144 for the second plurality of the rotating machine 100 in relation to patterns identified in one or more groups of operational periods for the second plurality of the rotating machine 100. In an even further example, the inter-operational features 1146 include windowed moving quantiles over the one or more groups of the operational periods, calculated ratios between select pairs of the windowed moving quantiles, fit sequences for select second features 1144 into line segments, fit sequences for select second features 1144 into curve segments or any other inter-operational feature in any suitable combination. In an even yet further example, the windowed moving quantiles include window sizes of approximately 14 days, approximately 30 days, approximately 60 days, approximately 90 days or any other suitable window size in any suitable combination. In another even yet further example, the windowed moving quantiles include quantile cut thresholds of approximately 10 percent, approximately 25 percent, approximately 50 percent, approximately 75 percent, approximately 90 percent or any other suitable quantile cut threshold in any suitable combination.

In yet another even yet further example, the calculated ratios include multiple ratios of approximately 14 days and approximately 10 percent divided by approximately 90 days and approximately 90 percent, approximately 30 days and approximately 10 percent divided by approximately 90 days and approximately 90 percent, approximately 60 days and approximately 10 percent divided by approximately 90 days and approximately 90 percent, approximately 30 days and approximately 25 percent divided by approximately 90 days and approximately 90 percent, approximately 30 days, approximately 50 percent divided by approximately 90 days and approximately 90 percent or any other suitable combination of multiple ratios in any suitable combination. In still another even yet further example, the line segments and the curve segments for the fit sequences include a line segment of degree 1, a line segment of degree 2, line segments with different maximum fitting errors for different moving windows, curve segments with different maximum fitting errors for different moving windows or any other suitable type of line segments or curve segments in any suitable combination.

In still another further example, the determining 506 of the select characteristics 1140 also includes determining 708 hyper-parameters 1148 for the second plurality of the rotating machine 100 based on the second features 1144 for the second plurality of the rotating machine 100 in relation to patterns identified in one or more groups of operational periods for the second plurality of the rotating machine 100. In an even yet further example, the hyper-parameters 1148 include a half-life, a window size, a spline degree, a maximum fitting error or any other suitable hyper parameter in any suitable combination. In still another example of the method 500, the determining 506 of the select characteristics 1140 includes determining 802 third features 1150 for the second plurality of the rotating machine 100 based on the pressure sensor data 1134 associated with the post-operational period. In a further example, the third features 1150 include i) identification of a shutdown event based at least in part on removal of power from a given rotating machine 100 of the second plurality of the rotating machine 100, ii) a calculated delta pressure based on a difference between an outlet pressure measurement of the rotating machine 100 and an inlet pressure measurement over time, iii) a first equilibrium delta pressure associated with the shutdown event, iv) a time after the shutdown event until at least one of a target delta pressure and a second equilibrium delta pressure is reached, v) changes in the calculated delta pressure after the shutdown event until at least one of the target delta pressure is reached, a predetermined delta pressure drop is reached and the second equilibrium delta pressure is reached, vi) a slope of the changes in the calculated delta pressure, vii) a change profile based at least in part on the changes in the calculated delta pressure and viii) identification of normalization coefficients to fit the change profile to predefined change profile curves.

In another further example, where at least a portion of the pressure sensor data 1134 was sampled at a 10 Hertz rate or higher, the third features 1150 are determined based at least in part on the portion of the pressure sensor data 1134 sampled at the 10 Hertz rate or higher. In yet another further example, the determining 506 of the select characteristics 1140 also includes determining 804 inter-operational features 1146 for the second plurality of the rotating machine 100 based on the third features 1150 for the second plurality of the rotating machine 100 in relation to patterns identified in one or more groups of operational periods for the second plurality of the rotating machine 100.

In an even further example, the inter-operational features 1146 includes windowed moving quantiles over the one or more groups of the operational periods, calculated ratios between select pairs of the windowed moving quantiles, fit sequences for select third features 1150 into line segments, fit sequences for select third features 1150 into curve segments or any other suitable inter-operational feature in any suitable combination. In an even yet further example, the windowed moving quantiles include window sizes of approximately 14 days, approximately 30 days, approximately 60 days, approximately 90 days or any other suitable window size in any suitable combination. In another even yet further example, the windowed moving quantiles include quantile cut thresholds of approximately 10 percent, approximately 25 percent, approximately 50 percent, approximately 75 percent, approximately 90 percent or any other suitable quantile cut threshold in any suitable combination.

In yet another even yet further example, the calculated ratios include multiple ratios of approximately 14 days and approximately 10 percent divided by approximately 90 days and approximately 90 percent, approximately 30 days and approximately 10 percent divided by approximately 90 days and approximately 90 percent, approximately 60 days and approximately 10 percent divided by approximately 90 days and approximately 90 percent, approximately 30 days and approximately 25 percent divided by approximately 90 days and approximately 90 percent and approximately 30 days, approximately 50 percent divided by approximately 90 days and approximately 90 percent or any other suitable multiple ratio in any suitable combination. In still another even yet further example, the line segments and the curve segments for the fit sequences include a line segment of degree 1, a line segment of degree 2, line segments with different maximum fitting errors for different moving windows, curve segments with different maximum fitting errors for different moving windows or any other suitable type of line segments or curve segments in any suitable combination.

In still another further example, the determining 506 of the select characteristics 1140 includes determining 806 hyper-parameters 1148 for the second plurality of the rotating machine 100 based on the third features 1150 for the second plurality of the rotating machine 100 in relation to patterns identified in one or more groups of operational periods for the second plurality of the rotating machine 100. In an even further example, the hyper-parameters 1148 include a half-life, a window size, a spline degree, a maximum fitting error or any other suitable hyper parameter in any suitable combination.

With reference again to FIGS. 1, 5, 9 and 11, in one or more examples, a method 900 (see FIG. 9) for generating a prediction model 1102 to predict a non-compliance condition 1602 of a rotating machine 100 with rotary bearings 102 includes the method 500 of FIG. 5 and continues from 508 to 902 where additional maintenance records 1130 for the first plurality of the rotating machine 100 are received from a maintenance record repository 1136 of a central storage device 1138. At 904, the average actual failure rate 1132 for the rotating machine 100 is updated to form an updated average actual failure rate 1132 based at least in part on the additional maintenance records 1130. At 906, the prediction model 1102 for the rotating machine 100 is revised based at least in part on the updated average actual failure rate 1132 and the select characteristics 1140.

With reference again to FIGS. 1, 5, 10 and 11, in one or more examples, a method 1000 (see FIG. 10) for generating a prediction model 1102 to predict a non-compliance condition 1602 of a rotating machine 100 with rotary bearings 102 includes the method 500 of FIG. 5 and continues from 508 to 1002 where additional pressure sensor data 1134 for the second plurality of the rotating machine 100 is received from a pressure sensor data repository 1112 of a central storage device 1138. At 1004, the select characteristics 1140 of the rotating machine 100 is updated to form updated select characteristics 1140 based at least in part on the additional pressure sensor data 1134. At 1006, the prediction model 1102 for the rotating machine 100 is revised based at least in part on the average actual failure rate 1132 and the updated select characteristics 1140.

Referring generally to FIGS. 1, 5, 11 and 16, by way of examples, the present disclosure is directed to a system 1100 for generating a prediction model 1102 to predict a non-compliance condition 1602 of a rotating machine 100 with rotary bearings 102. FIG. 1 provides an example of the rotating machine 100 with the rotary bearings 102. FIG. 5 provides an example of a method 500 for generating a prediction model 1102 to predict a non-compliance condition 1602 of a rotating machine 100 with rotary bearings 102. FIG. 11 provides an example of the system 1100 for generating the prediction model 1102 to predict the non-compliance condition 1602 of the rotating machine 100 with the rotary bearings 102. FIG. 16 provides an example of a system 1600 for predicting the non-compliance condition 1602 of the rotating machine 100 with the rotary bearings 102.

With reference again to FIGS. 1, 5, 11 and 16, in one or more examples, a system 1100 for generating a prediction model 1102 to predict a non-compliance condition 1602 of a rotating machine 100 with rotary bearings 102 includes at least one computing device 1104 and at least one storage device 1116. The at least one computing device 1104 includes at least one processor 1106, associated memory 1108 and a network interface 1110. The at least one computing device 1104 may also include a user input device 1152 and a user display device 1154. The network interface 1110 in operative communication with the at least one processor 1106 and configured to communicate with a pressure sensor data repository 1112 via a communication network 1114. The at least one storage device 1116 includes at least one application program storage device 1118, at least one model storage device 1126 and at least one data storage device 1128. The at least one application program storage device 1118 in operative communication with the at least one processor 1106 and configured to store a maintenance record analysis application program 1120, a sensor data analysis application program 1122 and a model generation application program 1124. The at least one model storage device 1126 is in operative communication with the at least one processor 1106 and configured to store the prediction model 1102 for the rotating machine 100. The at least one data storage device 1128 in operative communication with the at least one processor 1106 and configured to store maintenance records 1130 for a first plurality of the rotating machine 100, an average actual failure rate 1132 for the rotating machine 100 and pressure sensor data 1134 associated with a second plurality of the rotating machine 100.

In another example of the system 1100, the at least one processor 1106 and the network interface 1110 are configured to receive the maintenance records 1130 for the first plurality of the rotating machine 100 from a maintenance record repository 1136 of at least one central storage device 1138 via the communication network 1114. In a further example, the at least one central storage device 1138 includes one or more of at least one cloud storage device, at least one remote storage device and at least one local storage device.

In yet another example of the system 1100, the at least one processor 1106 is configured to determine the average actual failure rate 1132 for the rotating machine 100 based at least in part on processing the maintenance records 1130 for a first plurality of the rotating machine 100 using the maintenance record analysis application program 1120. The at least one processor 1106 and the network interface 1110 are configured to receive pressure sensor data 1134 relating to an inlet pressure and an outlet pressure for a second plurality of the rotating machine 100 from a pressure sensor data repository 1112 of at least one central storage device 1138 via the communication network 1114. The pressure sensor data 1134 having been recorded during at least one of a preoperational period, an operational period and a post-operational period of the second plurality of the rotating machine 100. The at least one processor 1106 is configured to determine select characteristics 1140 of the rotating machine 100 associated with at least one of the preoperational period, the operational period and the post-operational period based at least in part on processing the pressure sensor data 1134 using the sensor data analysis application program 1122. The at least one processor 1106 is configured to build the prediction model 1102 for the rotating machine 100 based at least in part on processing the average actual failure rate 1132 and the select characteristics 1140 using the model generation application program 1124.

In a further example, in conjunction with determining the select characteristics 1140, the at least one processor 1106 is configured to determine first features 1142 for the second plurality of the rotating machine 100 based on the pressure sensor data 1134 associated with the preoperational period using the sensor data analysis application program 1122. In another further example, in conjunction with determining the select characteristics 1140, the at least one processor 1106 is configured to determine second features 1144 for the second plurality of the rotating machine 100 based on the pressure sensor data 1134 associated with the operational period using the sensor data analysis application program 1122. In an even further example, in conjunction with determining the select characteristics 1140, the at least one processor 1106 is configured to determine inter-operational features 1146 for the second plurality of the rotating machine 100 based on the second features 1144 for the second plurality of the rotating machine 100 in relation to patterns identified in one or more groups of operational periods for the second plurality of the rotating machine 100. In another even further example, in conjunction with determining the select characteristics 1140, the at least one processor 1106 is configured to determine hyper-parameters 1148 for the second plurality of the rotating machine 100 based on the second features 1144 for the second plurality of the rotating machine 100 in relation to patterns identified in one or more groups of operational periods for the second plurality of the rotating machine 100.

In yet another further example, in conjunction with determining 506 of the select characteristics 1140, the at least one processor 1106 is configured to determine third features 1150 for the second plurality of the rotating machine 100 based on the pressure sensor data 1134 associated with the post-operational period using the sensor data analysis application program 1122. In an even further example, in conjunction with determining the select characteristics 1140, the at least one processor 1106 is configured to determine inter-operational features 1146 for the second plurality of the rotating machine 100 based on the third features 1150 for the second plurality of the rotating machine 100 in relation to patterns identified in one or more groups of operational periods for the second plurality of the rotating machine 100. In another even further example, in conjunction with determining the select characteristics 1140, the at least one processor 1106 is configured to determine hyper-parameters 1148 for the second plurality of the rotating machine 100 based on the third features 1150 for the second plurality of the rotating machine 100 in relation to patterns identified in one or more groups of operational periods fit sequences for select third features 1150 into line segments or curve segments of the operational periods for the second plurality of the rotating machine 100.

In still another further example, the at least one processor 1106 and the network interface 1110 are configured to receive additional maintenance records 1130 for the first plurality of the rotating machine 100 from a maintenance record repository 1136 of the at least one central storage device 1138 via the communication network 1114. The at least one processor 1106 is configured to update the average actual failure rate 1132 for the rotating machine 100 to form an updated average actual failure rate 1132 based at least in part on processing the additional maintenance records 1130 using the maintenance record analysis application program 1120. The at least one processor 1106 is configured to revise the prediction model 1102 for the rotating machine 100 based at least in part on processing the updated average actual failure rate 1132 and the select characteristics 1140 using the model generation application program 1124.

In still yet another further example, the at least one processor 1106 and the network interface 1110 are configured to receive additional pressure sensor data 1134 for the second plurality of the rotating machine 100 from the pressure sensor data repository 1112 of the at least one central storage device 1138 via the communication network 1114. The at least one processor 1106 is configured to update the select characteristics 1140 of the rotating machine 100 to form updated select characteristics 1140 based at least in part on processing the additional pressure sensor data 1134 using the sensor data analysis application program 1122. The at least one processor 1106 is configured to revise the prediction model 1102 for the rotating machine 100 based at least in part on processing the average actual failure rate and the updated select characteristics 1140 using the model generation application program 1124.

Referring generally to FIGS. 1, 5, 11 and 16, by way of examples, the present disclosure is directed to a non-transitory computer-readable medium with instructions that, when executed by at least one processor 1106, cause at least one computing device 1104 to perform a method 500 for generating a prediction model 1102 to predict a non-compliance condition 1602 of a rotating machine 100 with rotary bearings 102. FIG. 1 provides an example of the rotating machine 100 with the rotary bearings 102. FIG. 5 provides an example of the method 500 for generating a prediction model 1102 to predict a non-compliance condition 1602 of a rotating machine 100 with rotary bearings 102. FIG. 11 provides an example of a system 1100 for generating the prediction model 1102 to predict the non-compliance condition 1602 of the rotating machine 100 with the rotary bearings 102. FIG. 16 provides an example of a system 1600 for predicting the non-compliance condition 1602 of the rotating machine 100 with the rotary bearings 102.

With reference again to FIGS. 1, 5, 11 and 16, in one or more examples, a non-transitory computer-readable medium includes instructions that, when executed by at least one processor 1106, cause at least one computing device 1104 to perform a method 500 for generating a prediction model 1102 to predict a non-compliance condition 1602 of a rotating machine 100 with rotary bearings 102. In one or more example, the method 500 includes determining 502 an average actual failure rate 1132 for the rotating machine 100 based at least in part on maintenance records 1130 for a first plurality of the rotating machine 100. At 504, pressure sensor data 1134 relating to an inlet pressure and an outlet pressure for a second plurality of the rotating machine 100 is received. The pressure sensor data 1134 having been recorded during at least one of a preoperational period, an operational period and a post-operational period of the second plurality of the rotating machine 100. At 506, select characteristics 1140 of the rotating machine 100 associated with at least one of the preoperational period, the operational period and the post-operational period based at least in part on the pressure sensor data 1134 are determined. At 508, the prediction model 1102 for the rotating machine 100 is built based at least in part on the average actual failure rate 1132 and the select characteristics 1140.

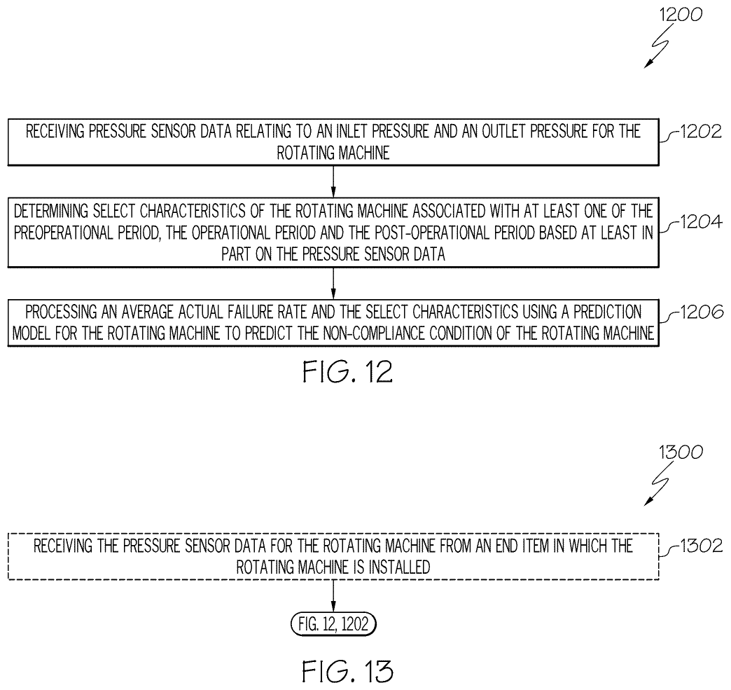

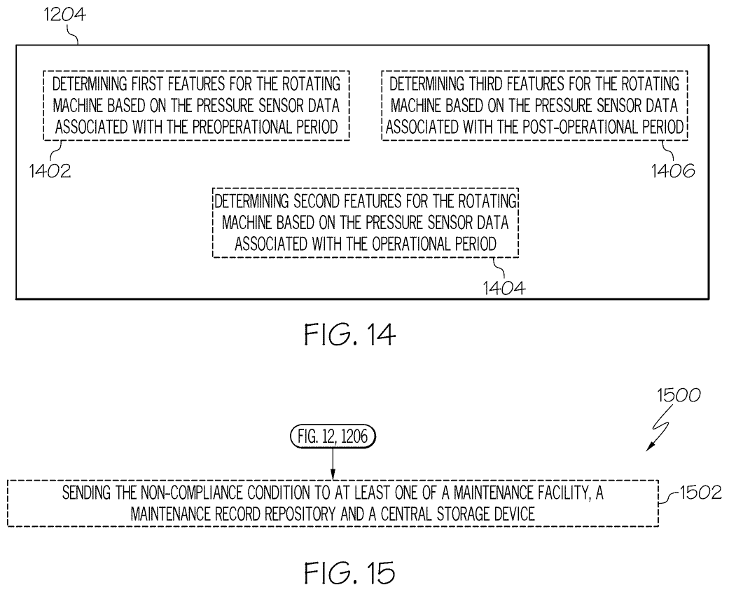

Referring generally to FIGS. 1 and 11-16, by way of examples, the present disclosure is directed to a method 1200, 1300, 1500 for predicting a non-compliance condition 1602 of a rotating machine 100 with rotary bearings 102. FIG. 1 provides an example of the rotating machine 100 with the rotary bearings 102. FIG. 11 provides an example of a system 1100 for generating the prediction model 1102 to predict the non-compliance condition 1602 of the rotating machine 100 with the rotary bearings 102. FIG. 12 provides an example of the method 1200 for predicting a non-compliance condition 1602 of a rotating machine 100 with rotary bearings 102. FIG. 13, in combination with FIG. 12, provides an example of the method 1300. FIG. 14 provides an example of the determining 1204 of the select characteristics 1140 of FIG. 12. FIG. 15, in combination with FIG. 12, provides an example of the method 1500. FIG. 16 provides an example of a system 1600 for predicting the non-compliance condition 1602 of the rotating machine 100 with the rotary bearings 102.

With reference again to FIGS. 1 and 11, 12 and 16, in one or more examples, a method 1200 (see FIG. 12) for predicting a non-compliance condition 1602 of a rotating machine 100 with rotary bearings 102 includes receiving 1202 pressure sensor data 1134 relating to an inlet pressure and an outlet pressure for the rotating machine 100. The pressure sensor data 1134 having been recorded during at least one of a preoperational period, an operational period and a post-operational period of the rotating machine 100. At 1204, select characteristics 1140 of the rotating machine 100 associated with at least one of the preoperational period, the operational period and the post-operational period based at least in part on the pressure sensor data 1134 are determined. At 1206, an average actual failure rate 1132 and the select characteristics 1140 are processed using a prediction model 1102 for the rotating machine 100 to predict the non-compliance condition 1602 of the rotating machine 100.

In another example of the method 1200, the non-compliance condition 1602 includes a degraded condition, a failure condition, or any other suitable non-compliance condition in any suitable combination. In yet another example of the method 1200, the rotating machine 100 includes a compressor, a turbine, a pump, an air cycle machine, a cabin air compressor or any other suitable rotating machine in any suitable combination. In still another example of the method 1200, the rotary bearings 102 includes fluid bearings, air bearings, aerodynamic bearings, aerostatic bearings, fluid dynamic bearings, foil bearings, hydrodynamic bearings, tilting-pad fluid bearings, fluid static bearings, hydrostatic bearings, gas bearings, water-lubricated rubber bearings, plain bearings, rolling-element bearings, ball bearings, roller bearings, jewel bearings, magnetic bearings, flexure bearings or any other suitable rotary bearings in any suitable combination. In still yet another example of the method 1200, the prediction model 1102 for the rotating machine 100 is associated with a select manufacturer and a select model number of the rotating machine 100. In another example of the method 1200, the prediction model 1102 for the rotating machine 100 is associated with a select manufacturer and select model numbers of the rotary bearings 102.

In yet another example of the method 1200, the pressure sensor data 1134 includes inlet pressure measurements by a first pressure sensor 104 disposed proximate an inlet of the rotating machine 100 and outlet pressure measurements by a second pressure sensor 106 disposed proximate an outlet of the rotating machine 100. In a further example, at least one of the first pressure sensor 104 and the second pressure sensor 106 are external in relation to the rotating machine 100. In another further example, at least one of the first pressure sensor 104 and the second pressure sensor 106 are internal in relation to the rotating machine 100.

In yet another further example, the pressure sensor data 1134 includes unique identifying information associated with the rotating machine 100. In still another further example, the pressure sensor data 1134 includes unique identifying information associated with the rotary bearings 102 in the rotating machine 100. In still yet another further example, the pressure sensor data 1134 includes unique identifying information associated with an end item 108 in which the rotating machine 100 is installed. In an even further example, the end item 108 includes an aircraft, a rotorcraft, a bus, a train conductor car, train crew quarters, a passenger train car, a passenger transport vehicle, a military transport vehicle, an operational military vehicle, a battle tank, a power plant, an unmanned air vehicle, a ship, a ferry, a cruise ship, a military ship, a ship's bridge room, a ship's engine control room, ship crew quarters, ship passenger quarters, a commercial building, a residential building or any other suitable end item in any suitable combination.

In another further example, the pressure sensor data 1134 includes temporal information associated with the inlet pressure measurements and the outlet pressure measurements. In yet another further example, the pressure sensor data 1134 includes an indicator associating the inlet pressure measurements and the outlet pressure measurements with the preoperational period, the operational period or the post-operational period. In still another example of the method 1200, the rotating machine 100 is deactivated during the preoperational period which ends when power is applied to the rotating machine 100. In still yet another example of the method 1200, the operational period begins when power is applied to the rotating machine 100 and ends when the power is removed. In another example of the method 1200, the post-operational period begins when power is removed from the rotating machine 100 and ends when a pressure differential between an outlet of the rotating machine 100 and an inlet of the rotating machine 100 is nominal and stable for a predetermined time.

With reference again to FIGS. 1 and 11-13, in one or more examples, a method 1300 (see FIG. 13) for predicting a non-compliance condition 1602 of a rotating machine 100 with rotary bearings 102 includes the method 1200 of FIG. 12. The method 1300 begins at 1302 where the pressure sensor data 1134 for the rotating machine 100 is received from an end item 108 in which the rotating machine 100 is installed. The method 1300 continues from 1302 to 1202.

With reference again to FIGS. 1, 11, 12 and 14, in another example of the method 1200, the determining 1204 of the select characteristics 1140 includes determining 1402 first features 1142 for the rotating machine 100 based on the pressure sensor data 1134 associated with the preoperational period. In a further example, the first features 1142 includes a preoperational delta pressure, an equilibrium delta pressure based at least in part on the preoperational delta pressure or any other suitable preoperational feature in any suitable combination.

In yet another example of the method 1200, the determining 1204 of the select characteristics 1140 includes determining 1404 second features 1144 for the rotating machine 100 based on the pressure sensor data 1134 associated with the operational period. In a further example, the second features 1144 include i) identification of a startup event based at least in part on application of power to the rotating machine 100, ii) a calculated delta pressure based on a difference between an outlet pressure measurement of the rotating machine 100 and an inlet pressure measurement over time, iii) a first equilibrium delta pressure associated with the startup event, iv) a time after the startup event until at least one of a target delta pressure and a second equilibrium delta pressure is reached, v) changes in the calculated delta pressure after the startup event until at least one of the target delta pressure is reached, a predetermined delta pressure increase is reached and the second equilibrium delta pressure is reached, vi) a slope of the changes in the calculated delta pressure, vii) a change profile based at least in part on the changes in the calculated delta pressure, viii) identification of normalization coefficients to fit the change profile to predefined change profile curves or any other suitable operational feature in any suitable combination.

In another further example, where at least a portion of the pressure sensor data 1134 was sampled at a 20 Hertz rate or higher, the second features 1144 are determined based at least in part on the portion of the pressure sensor data 1134 sampled at the 20 Hertz rate or higher. In yet another further example, the second features 1144 include identification of a startup event based on a control mode change for the rotating machine 100 from off to on, a rotation speed for the rotating machine 100 increasing from nominal to a higher speed or any other suitable operational feature in any suitable combination. The rotation speed is calculated from an electric frequency, an optical sensor signal or any other suitable measurable parameter indicative of rotation speed in any suitable combination. In still another further example, the second features 1144 includes an acceleration rate of a calculated delta pressure based on a difference between an outlet pressure measurement of the rotating machine 100 and an inlet pressure measurement over time.

In still another example of the method 1200, the determining 1204 of the select characteristics 1140 includes determining 1406 third features 1150 for the rotating machine 100 based on the pressure sensor data 1134 associated with the post-operational period. In a further example, the third features 1150 include i) identification of a shutdown event based at least in part on removal of power from the rotating machine 100, ii) a calculated delta pressure based on a difference between an outlet pressure measurement of the rotating machine 100 and an inlet pressure measurement over time, iii) a first equilibrium delta pressure associated with the shutdown event, iv) a time after the shutdown event until at least one of a target delta pressure and a second equilibrium delta pressure is reached, v) changes in the calculated delta pressure after the shutdown event until at least one of the target delta pressure is reached, a predetermined delta pressure drop is reached and the second equilibrium delta pressure is reached, vi) a slope of the changes in the calculated delta pressure, vii) a change profile based at least in part on the changes in the calculated delta pressure, viii) identification of normalization coefficients to fit the change profile to predefined change profile curves or any other suitable post-operational feature in any suitable combination.

In another further example, where at least a portion of the pressure sensor data 1134 was sampled at a 10 Hertz rate or higher, the third features 1150 are determined based at least in part on the portion of the pressure sensor data 1134 sampled at the 10 Hertz rate or higher. In yet another further example, the third features 1150 include identification of a shutdown event based on a control mode change for the rotating machine 100 from on to off, a rotation speed for the rotating machine 100 decreasing from a higher speed to a nominal speed or any other suitable post-operational feature in any suitable combination. The rotation speed is calculated from an electric frequency, an optical sensor signal or any other suitable measurable parameter indicative of rotation speed in any suitable combination. In still another further example, the third features 1150 includes a deceleration rate of a calculated delta pressure based on a difference between an outlet pressure measurement of the rotating machine 100 and an inlet pressure measurement over time.

With reference again to FIGS. 11, 12, 15 and 16, in one or more examples, a method 1500 (see FIG. 15) for predicting a non-compliance condition 1602 of a rotating machine 100 with rotary bearings 102 includes the method 1200 of FIG. 12 and continues from 1206 to 1502 where the non-compliance condition 1602 is sent to a maintenance facility 1622 associated with maintenance of the end item 108, a maintenance record repository 1136, a central storage device 1138 or any other suitable location in any suitable combination. In another example of the method 1500, the central storage device 1138 includes a cloud storage device, a remote storage device, a local storage device or any other suitable central storage device in any suitable combination. In yet another example of the method 1500, the non-compliance condition 1602 includes an approximate date for the non-compliance condition 1602, an approximate number of days until the non-compliance condition 1602, a first probability the non-compliance condition 1602 will occur within approximately 14 days, a second probability the non-compliance condition 1602 will occur within approximately 30 days, a third probability the non-compliance condition 1602 will occur within approximately 60 days, a fourth probability the non-compliance condition 1602 will occur within approximately 90 days or any other suitable.non-compliance condition in any suitable combination.

Referring generally to FIGS. 1, 11, 12 and 16, by way of examples, the present disclosure is directed to a system 1600 for predicting a non-compliance condition 1602 of a rotating machine 100 with rotary bearings 102. FIG. 1 provides an example of the rotating machine 100 with the rotary bearings 102. FIG. 11 provides an example of a system 1100 for generating the prediction model 1102 to predict the non-compliance condition 1602 of the rotating machine 100 with the rotary bearings 102. FIG. 12 provides an example of the method 1200 for predicting a non-compliance condition 1602 of a rotating machine 100 with rotary bearings 102. FIG. 16 provides an example of a system 1600 for predicting the non-compliance condition 1602 of the rotating machine 100 with the rotary bearings 102.

With reference again to FIGS. 1, 11, 12 and 16, in one or more examples, a system 1600 for predicting a non-compliance condition 1602 of a rotating machine 100 with rotary bearings 102 includes at least one computing device 1604 and at least one storage device 1612. The at least one computing device 1604 includes at least one processor 1606, associated memory 1608 and a network interface 1610. The at least one computing device 1604 may also include a user input device 1624 and a user display device 1626. The network interface 1610 in operative communication with the at least one processor 1606 and configured to communicate with an end item 108 in which the rotating machine 100 is installed via a communication network 1114. The at least one storage device 1612 includes at least one application program storage device 1614, at least one model storage device 1618 and at least one data storage device 1620. The at least one application program storage device 1614 in operative communication with the at least one processor 1606 and configured to store a sensor data analysis application program 1122 and a maintenance prediction application program 1616. The at least one model storage device 1618 is in operative communication with the at least one processor 1606 and configured to store a prediction model 1102 for the rotating machine 100. The at least one data storage device 1620 in operative communication with the at least one processor 1606 and configured to store an average actual failure rate 1132 for the rotating machine 100 and pressure sensor data 1134 associated with the rotating machine 100.

In another example of the system 1600, the at least one processor 1606 and the network interface 1610 are configured to receive pressure sensor data 1134 relating to an inlet pressure and an outlet pressure for the rotating machine 100. The pressure sensor data 1134 having been recorded during at least one of a preoperational period, an operational period and a post-operational period of the rotating machine 100. The at least one processor 1606 is configured to determine select characteristics 1140 of the rotating machine 100 associated with at least one of the preoperational period, the operational period and the post-operational period based at least in part on the pressure sensor data 1134 using the sensor data analysis application program 1122. The at least one processor 1606 is configured to process the average actual failure rate 1132 and the select characteristics 1140 using the prediction model 1102 for the rotating machine 100 and the maintenance prediction application program 1616 to predict the non-compliance condition 1602 of the rotating machine 100.

In a further example, in conjunction with determining the select characteristics 1140, the at least one processor 1606 is configured to determine first features 1142 for the rotating machine 100 based on the pressure sensor data 1134 associated with the preoperational period using the sensor data analysis application program 1122.

In another further example, in conjunction with determining the select characteristics 1140, the at least one processor 1606 is configured to determine second features 1144 for the rotating machine 100 based on the pressure sensor data 1134 associated with the operational period using the sensor data analysis application program 1122.

In yet another further example, in conjunction with determining the select characteristics 1140, the at least one processor 1606 is configured to determine third features 1150 for the rotating machine 100 based on the pressure sensor data 1134 associated with the post-operational period using the sensor data analysis application program 1122.

In still another further example, the at least one processor 1606 and the network interface 1610 are configured to send the non-compliance condition 1602 to a maintenance facility 1622 associated with maintenance of the end item 108, a maintenance record repository 1136, a central storage device 1138 or any other suitable location in any suitable combination.

In still yet another further example, the non-compliance condition 1602 includes an approximate date for the non-compliance condition 1602, an approximate number of days until the non-compliance condition 1602, a first probability the non-compliance condition 1602 will occur within approximately 14 days, a second probability the non-compliance condition 1602 will occur within approximately 30 days, a third probability the non-compliance condition 1602 will occur within approximately 60 days, a fourth probability the non-compliance condition 1602 will occur within approximately 90 days or any other suitable non-compliance condition in any suitable combination.

Referring generally to FIGS. 1, 11, 12 and 16, by way of examples, the present disclosure is directed to a non-transitory computer-readable medium with instructions that, when executed by at least one processor 1606, cause at least one computing device 1604 to perform a method 1200 for predicting a non-compliance condition 1602 of a rotating machine 100 with rotary bearings 102. FIG. 1 provides an example of the rotating machine 100 with the rotary bearings 102. FIG. 11 provides an example of a system 1100 for generating the prediction model 1102 to predict the non-compliance condition 1602 of the rotating machine 100 with the rotary bearings 102. FIG. 12 provides an example of the method 1200 for predicting a non-compliance condition 1602 of a rotating machine 100 with rotary bearings 102. FIG. 16 provides an example of a system 1600 for predicting the non-compliance condition 1602 of the rotating machine 100 with the rotary bearings 102.

With reference again to FIGS. 1, 11, 12 and 16, in one or more examples, a non-transitory computer-readable medium includes instructions that, when executed by at least one processor 1606, cause at least one computing device 1604 to perform a method 1200 for predicting a non-compliance condition 1602 of a rotating machine 100 with rotary bearings 102. In one or more example, the method 1200 includes receiving 1202 pressure sensor data 1134 relating to an inlet pressure and an outlet pressure for the rotating machine 100. The pressure sensor data 1134 having been recorded during at least one of a preoperational period, an operational period and a post-operational period of the rotating machine 100. At 1204, select characteristics 1140 of the rotating machine 100 associated with at least one of the preoperational period, the operational period and the post-operational period are determined based at least in part on the pressure sensor data 1134. At 1206, an average actual failure rate 1132 and the select characteristics 1140 are processed using a prediction model 1102 for the rotating machine 100 to predict the non-compliance condition 1602 of the rotating machine 100.

Examples of methods 500, 600, 900, 1000 and systems 1100 for generating a prediction model to predict a non-compliance condition 1602 of a rotating machine 100 with rotary bearings 102, non-transitory computer-readable medium associated with implementing the generating methods, methods 1200, 1300, 1500 and systems 1600 for predicting a non-compliance condition 1602 of a rotating machine 100 with rotary bearings 102 and non-transitory computer-readable medium associated with implementing the predicting methods may be related to or used in the context of aircraft design, manufacture and maintenance. Although an aircraft example is described, the examples and principles disclosed herein may be applied to other products in the aerospace industry and other industries, such as the automotive industry, the space industry, the construction industry and other design and manufacturing industries. Accordingly, in addition to aircraft, the examples and principles disclosed herein may apply to methods 500, 600, 900, 1000 for generating a prediction model to predict a non-compliance condition 1602 of a rotating machine 100 with rotary bearings 102 and methods 1200, 1300, 1500 for using the prediction model in the design, manufacture and maintenance of various types of vehicles and in the design and construction of various types of transportation systems.

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

As used herein, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

In FIGS. 5-10 and 12-15, referred to above, the blocks may represent operations, steps, and/or portions thereof, and lines connecting the various blocks do not imply any particular order or dependency of the operations or portions thereof. It will be understood that not all dependencies among the various disclosed operations are necessarily represented. FIGS. 5-10 and 12-15 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

FIGS. 1, 11 and 16, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1, 11 and 16, referred to above, need be included in every example and not all elements, features, and/or components described herein are necessarily depicted in each illustrative example. Accordingly, some of the elements, features, and/or components described and illustrated in FIGS. 1, 11 and 16 may be combined in various ways without the need to include other features described and illustrated in FIGS. 1, 11 and 16, other drawing figures, and/or the accompanying disclosure, even though such combination or combinations are not explicitly illustrated herein. Similarly, additional features not limited to the examples presented, may be combined with some or all the features shown and described herein. Unless otherwise explicitly stated, the schematic illustrations of the examples depicted in FIGS. 1, 11 and 16, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1, 11 and 16, and such elements, features, and/or components may not be discussed in detail herein with reference to each of FIGS. 1, 11 and 16. Similarly, all elements, features, and/or components may not be labeled in each of FIGS. 1, 11 and 16, but reference numerals associated therewith may be utilized herein for consistency.

Further, references throughout the present specification to features, advantages, or similar language used herein do not imply that all the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

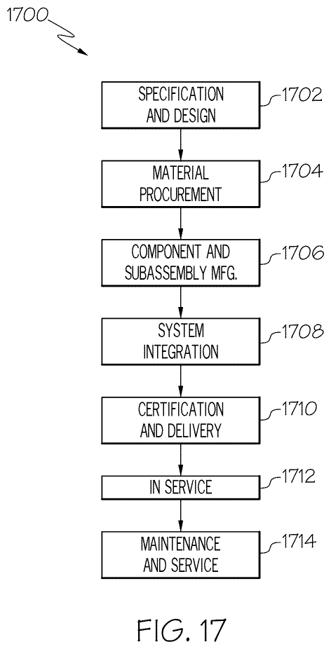

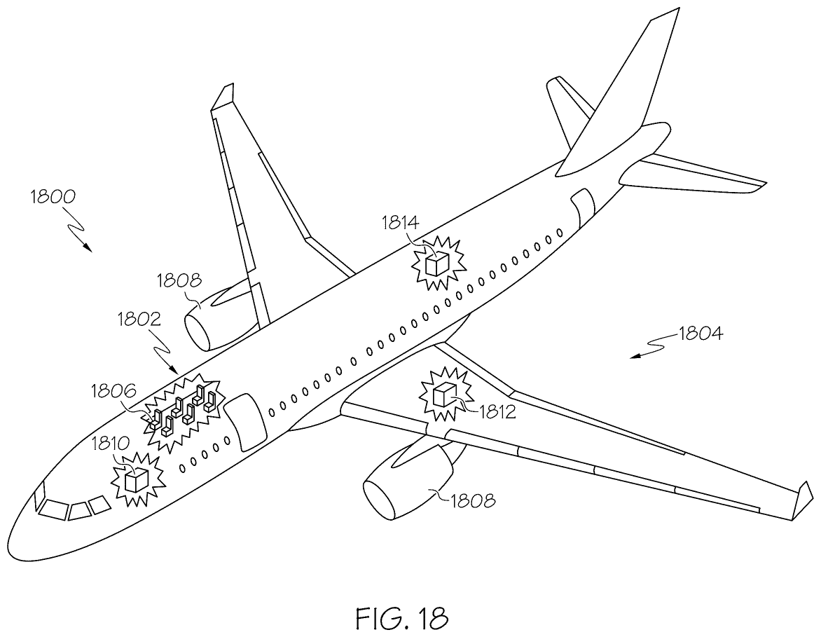

Examples of the subject matter disclosed herein may be described in the context of aircraft manufacturing and service method 1700 as shown in FIG. 17 and aircraft 1800 as shown in FIG. 18. In one or more examples, the disclosed methods and systems for analysis of fastened structures may be used in aircraft manufacturing. During pre-production, the service method 1700 may include specification and design (block 1702) of aircraft 1800 and material procurement (block 1704). During production, component and subassembly manufacturing (block 1706) and system integration (block 1708) of aircraft 1800 may take place. Thereafter, aircraft 1800 may go through certification and delivery (block 1710) to be placed in service (block 1712). While in service, aircraft 1800 may be scheduled for routine maintenance and service (block 1714). Routine maintenance and service may include modification, reconfiguration, refurbishment, etc. of one or more systems of aircraft 1800.

Each of the processes of the service method 1700 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

As shown in FIG. 18, aircraft 1800 produced by the service method 1700 may include airframe 1802 with a plurality of high-level systems 1804 and interior 1806. Examples of high-level systems 1804 include one or more of propulsion system 1808, electrical system 1810, hydraulic system 1812, and environmental system 1814. Any number of other systems may be included. Although an aerospace example is shown, the principles disclosed herein may be applied to other industries, such as the automotive industry. Accordingly, in addition to aircraft 1800, the principles disclosed herein may apply to other vehicles, e.g., land vehicles, marine vehicles, space vehicles, etc.

The disclosed methods and systems for analysis of fastened structures may be employed during any one or more of the stages of the manufacturing and service method 1700. For example, components or subassemblies corresponding to component and subassembly manufacturing (block 1706) may be fabricated or manufactured in a manner similar to components or subassemblies produced while aircraft 1800 is in service (block 1712). Also, one or more examples of the tooling set(s), system(s), method(s), or any combination thereof may be utilized during production stages (block 1706 and block 1708), for example, by substantially expediting assembly of or reducing the cost of aircraft 1800. Similarly, one or more examples of the tooling set, system or method realizations, or a combination thereof, may be utilized, for example and without limitation, while aircraft 1800 is in service (block 1712) and/or during maintenance and service (block 1714).

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the methods 500, 600, 900, 1000 and systems 1100 for generating a prediction model to predict a non-compliance condition 1602 of a rotating machine 100 with rotary bearings 102, non-transitory computer-readable medium associated with implementing the generating methods, methods 1200, 1300, 1500 and systems 1600 for predicting a non-compliance condition 1602 of a rotating machine 100 with rotary bearings 102 and non-transitory computer-readable medium associated with implementing the predicting methods have been shown and described, modifications may occur to those skilled in the art upon reading the specification. The present application includes such modifications and is limited only by the scope of the claims.

1. A method for generating a prediction model to predict a non-compliance condition of a rotating machine with rotary bearings, the method comprising:
determining an average actual failure rate for the rotating machine based at least in part on maintenance records for a first plurality of the rotating machine;
receiving pressure sensor data relating to an inlet pressure and an outlet pressure for a second plurality of the rotating machine, the pressure sensor data having been recorded during at least one of a preoperational period, an operational period and a post-operational period of the second plurality of the rotating machine;
determining select characteristics of the rotating machine associated with at least one of the preoperational period, the operational period and the post-operational period based at least in part on the pressure sensor data; and
building the prediction model for the rotating machine based at least in part on the average actual failure rate and the select characteristics.

2. The method of claim 1 wherein the non-compliance condition comprises at least one of a degraded condition and a failure condition.

3-7. (canceled)

8. The method of claim 1, further comprising:
receiving the maintenance records for the first plurality of the rotating machine from a maintenance record repository of a central storage device.

9. (canceled)

10. The method of claim 1 wherein the pressure sensor data comprises inlet pressure measurements by a first pressure sensor disposed proximate an inlet of the rotating machine and outlet pressure measurements by a second pressure sensor disposed proximate an outlet of the rotating machine.

11. The method of claim 10 wherein at least one of the first pressure sensor and the second pressure sensor are external in relation to the rotating machine.

12-16. (canceled)

17. The method of claim 10 wherein the pressure sensor data comprises temporal information associated with the inlet pressure measurements and the outlet pressure measurements.

18. The method of claim 10 wherein the pressure sensor data comprises an indicator associating the inlet pressure measurements and the outlet pressure measurements with the preoperational period, the operational period or the post-operational period.

19. The method of claim 1 wherein the rotating machine is deactivated during the preoperational period which ends when power is applied to the rotating machine.

20. The method of claim 1 wherein the operational period begins when power is applied to the rotating machine and ends when the power is removed.

21. The method of claim 1 wherein the post-operational period begins when power is removed from the rotating machine and ends when a pressure differential between an outlet of the rotating machine and an inlet of the rotating machine is nominal and stable for a predetermined time.

22. The method of claim 1, further comprising:
receiving the pressure sensor data for the second plurality of the rotating machine from a pressure sensor data repository of a central storage device.

23. The method of claim 1, the determining of the select characteristics comprising:
determining first features for the second plurality of the rotating machine based on the pressure sensor data associated with the preoperational period.

24. (canceled)

25. The method of claim 1, the determining of the select characteristics comprising:
determining second features for the second plurality of the rotating machine based on the pressure sensor data associated with the operational period.

26. The method of claim 25 wherein the second features comprise at least one of i) identification of a startup event based at least in part on application of power to a given rotating machine of the second plurality of the rotating machine, ii) a calculated delta pressure based on a difference between an outlet pressure measurement of the rotating machine and an inlet pressure measurement over time, iii) a first equilibrium delta pressure associated with the startup event, iv) a time after the startup event until at least one of a target delta pressure and a second equilibrium delta pressure is reached, v) changes in the calculated delta pressure after the startup event until at least one of the target delta pressure is reached, a predetermined delta pressure increase is reached and the second equilibrium delta pressure is reached, vi) a slope of the changes in the calculated delta pressure, vii) a change profile based at least in part on the changes in the calculated delta pressure and viii) identification of normalization coefficients to fit the change profile to predefined change profile curves.

27. (canceled)

28. The method of claim 25, the determining of the select characteristics further comprising:
determining inter-operational features for the second plurality of the rotating machine based on the second features for the second plurality of the rotating machine in relation to patterns identified in one or more groups of operational periods for the second plurality of the rotating machine.

29-33. (canceled)

34. The method of claim 25, the determining of the select characteristics further comprising:
determining hyper-parameters for the second plurality of the rotating machine based on the second features for the second plurality of the rotating machine in relation to patterns identified in one or more groups of operational periods for the second plurality of the rotating machine.

35. (canceled)

36. The method of claim 1, the determining of the select characteristics comprising:
determining third features for the second plurality of the rotating machine based on the pressure sensor data associated with the post-operational period.

37. The method of claim 36 wherein the third features comprise at least one of i) identification of a shutdown event based at least in part on removal of power from a given rotating machine of the second plurality of the rotating machine, ii) a calculated delta pressure based on a difference between an outlet pressure measurement of the rotating machine and an inlet pressure measurement over time, iii) a first equilibrium delta pressure associated with the shutdown event, iv) a time after the shutdown event until at least one of a target delta pressure and a second equilibrium delta pressure is reached, v) changes in the calculated delta pressure after the shutdown event until at least one of the target delta pressure is reached, a predetermined delta pressure drop is reached and the second equilibrium delta pressure is reached, vi) a slope of the changes in the calculated delta pressure, vii) a change profile based at least in part on the changes in the calculated delta pressure and viii) identification of normalization coefficients to fit the change profile to predefined change profile curves.

38. The method of claim 36 wherein, where at least a portion of the pressure sensor data was sampled at a 10 Hertz rate or higher, the third features are determined based at least in part on the portion of the pressure sensor data sampled at the 10 Hertz rate or higher.

39. The method of claim 36, the determining of the select characteristics further comprising:
determining inter-operational features for the second plurality of the rotating machine based on the third features for the second plurality of the rotating machine in relation to patterns identified in one or more groups of operational periods for the second plurality of the rotating machine.

40-44. (canceled)

45. The method of claim 36, the determining of the select characteristics comprising:
determining hyper-parameters for the second plurality of the rotating machine based on the third features for the second plurality of the rotating machine in relation to patterns identified in one or more groups of operational periods for the second plurality of the rotating machine.

46. (canceled)

47. The method of claim 1, further comprising:
receiving additional maintenance records for the first plurality of the rotating machine from a maintenance record repository of a central storage device;
updating the average actual failure rate for the rotating machine to form an updated average actual failure rate based at least in part on the additional maintenance records; and
revising the prediction model for the rotating machine based at least in part on the updated average actual failure rate and the select characteristics.

48. The method of claim 1, further comprising:
receiving additional pressure sensor data for the second plurality of the rotating machine from a pressure sensor data repository of a central storage device;
updating the select characteristics of the rotating machine to form updated select characteristics based at least in part on the additional pressure sensor data; and
revising the prediction model for the rotating machine based at least in part on the average actual failure rate and the updated select characteristics.

49. A system for generating a prediction model to predict a non-compliance condition of a rotating machine with rotary bearings, the system comprising:
at least one computing device, comprising:
at least one processor and associated memory; and
a network interface in operative communication with the at least one processor and configured to communicate with a pressure sensor data repository via a communication network; and
at least one storage device, comprising:
at least one application program storage device in operative communication with the at least one processor and configured to store a maintenance record analysis application program, a sensor data analysis application program and a model generation application program;
at least one model storage device in operative communication with the at least one processor and configured to store the prediction model for the rotating machine; and
at least one data storage device in operative communication with the at least one processor and configured to store maintenance records for a first plurality of the rotating machine, an average actual failure rate for the rotating machine and pressure sensor data associated with a second plurality of the rotating machine.

50-61. (canceled)

62. A method for predicting a non-compliance condition of a rotating machine with rotary bearings, the method comprising:
receiving pressure sensor data relating to an inlet pressure and an outlet pressure for the rotating machine, the pressure sensor data having been recorded during at least one of a preoperational period, an operational period and a post-operational period of the rotating machine;
determining select characteristics of the rotating machine associated with at least one of the preoperational period, the operational period and the post-operational period based at least in part on the pressure sensor data; and
processing an average actual failure rate and the select characteristics using a prediction model for the rotating machine to predict the non-compliance condition of the rotating machine.

63-95. (canceled)

96. A system for predicting a non-compliance condition of a rotating machine with rotary bearings, the system comprising:
at least one computing device, comprising:
at least one processor and associated memory; and
a network interface in operative communication with the at least one processor and configured to communicate with an end item in which the rotating machine is installed via a communication network; and
at least one storage device, comprising:
at least one application program storage device in operative communication with the at least one processor and configured to store a sensor data analysis application program and a maintenance prediction application program;
at least one model storage device in operative communication with the at least one processor and configured to store a prediction model for the rotating machine; and
at least one data storage device in operative communication with the at least one processor and configured to store an average actual failure rate for the rotating machine and pressure sensor data associated with the rotating machine.

97-104. (canceled)
